(19) United States
(12) Patent Application Publication
(10) Pub. No.: US 2017/0253711 A1
(43) Pub. Date: Sep. 7, 2017

(54) FLEXIBLE, OPEN-CELL THERMOSET FOAMS AND BLOWING AGENTS AND METHODS FOR MAKING SAME

(71) Applicant: HONEYWELL INTERNATIONAL INC., Morris Plains, NJ (US)

(72) Inventors: Ronald S. GROSSMAN, Buffalo, NY (US); Pranav METHA, Pune (IN)

(21) Appl. No.: 15/510,292

(22) PCT Filed: Apr. 30, 2015
(86) PCT No.: PCT/US15/28674

§ 371 Date: Mar. 10, 2017

Related U.S. Application Data
(60) Provisional application No. 62/053,060, filed on Sep. 19, 2014.

(51) Int. Cl. C08J 9/14; C08G 18/32; C08G 18/48; C08G 18/76

(52) U.S. Cl. CPC C08J 9/146; C08G 18/7664; C08G 18/3206; C08G 18/4829; C08J 2205/05; C08J 2205/06; C08J 2203/142; C08J 2375/04; C08G 2101/0008

(57) ABSTRACT

Disclosed are methods and compositions for forming a flexible, open cell foams which utilize a thermosetting composition comprising one or more components capable of forming a thermoset matrix and a blowing agent comprising at least one chemical blowing agent, such as water, and at least one physical blowing agent includes at least one of HFO-1336mzz, HFO-S1438mzz (preferably E-HFO-1438mzz) and HFO-1447fz, to form a flexible foam.

This application claims priority to U.S. Provisional Application No. 62/053,060, filed Sep. 19, 2014, the entire contents of which is hereby incorporated by reference.

### FIELD OF THE INVENTION

The present invention relates to improved open-cell flexible thermoset foams and to compositions and methods for forming such foams.

### BACKGROUND OF THE INVENTION

One of the most common thermoset flexible foams are polyurethane foams. Such foams are typically prepared by reacting a polyisocyanate with an active hydrogen-containing compound, such as a polyol, in the presence of a blowing agent and other optional ingredients.

Catalysts are employed to promote two major reactions to produce the foam. One reaction is primarily a chain extending isocyanate-hydroxyl reaction or gelation reaction by which a hydroxyl-containing molecule is reacted with an isocyanate-containing molecule to form a urethane linkage. The progress of this reaction increases the viscosity of the mixture, and generally contributes to crosslink formation with polyfunctional polyols (i.e. polyols having a nominal functionality above 2). The second major reaction comprises an isocyanate-water reaction which forms carbon dioxide as a reaction product. The CO2 thus generated serves to “blow” or assist in the “blowing” of the foam. The in-situ generation of carbon dioxide by this reaction plays an essential part in the preparation of many flexible polyurethane foams, including open-cell flexible foams. Heretofore such foams have frequently been referred to as “water-blown” flexible polyurethane foams.

While the use of water as the primary source of blowing agent in such foams is typical and frequently adequate, problems and/or deficiencies can be associated with such water-blown flexible foams. For example, in order to reduce the density of such foams, which in many applications is a highly desirable result, it is generally known that it might be possible to achieve a decrease in foam density by increasing the amount of the blowing agent. For water-blown foams, increasing the amount of water in the foamable mixture is a common approach to decrease foam density since additional water in the foaming composition will generally result in more CO2 and hence increase the amount of blowing agent. However, the isocyanate-water reaction that produces the carbon dioxide blowing agent (i.e. the water reaction) is exothermic. As a result, the use of additional water to generate additional CO2 blowing agent has the consequence of increasing the heat that is generated in the foaming reaction. In many cases, this additional heat can cause serious problems for the foaming process and/or the foam product produced. These potential disadvantages can be understood with reference to the types of intended applications for the flexible foam and the types of processes used to form the foam. As a result, limitations have been observed on the ability to increase water levels generally to about 3.8%; above this level problems have been known to arise, including the fact that the foam tends to become boardy and has a sandpaper feel leading to poor compression set

Flexible, open-cell polyurethane foams have applications in a variety of products and, depending on the end use, can be tailor made to fit the particular application and desired physical properties. The polyurethane industry has come to recognize two, generally distinct, categories of flexible foam products: high resilience foams and conventional, lower resilience foams. High resilience (HR) foam is widely used for furniture cushions, mattresses, automotive cushions and padding, and numerous other applications requiring foams have properties similar to those describe above. Conventional foam also is used in these applications and finds additional applications in the areas of carpet underlays and packaging materials.

One particular type of HR foam is flexible, viscoelastic polyurethane foam (also known as “dead” foam, “slow recovery” foam, or “high damping” foam). This type of foam is characterized by slow, gradual recovery from compression. While most of the physical properties of viscoelastic foams resemble those of conventional foams, the resilience of viscoelastic foams is much lower, generally less than about 15%. Suitable applications for viscoelastic foam take advantage of its shape conforming, energy attenuating, and sound damping characteristics. For example, the foam can be used in mattresses to reduce pressure points, in athletic padding or helmets as a shock absorber, and in automotive interiors for soundproofing.

Various synthetic approaches have been used to make viscoelastic foam. Formulators have modified the amount and type of polyol(s), polyisocyanate, surfactants, foaming catalysts, fillers (see, e.g., U.S. Pat. No. 4,367,259, which is incorporated herein by reference), or other components, to arrive at foams having low resilience, good softness, and the right processing characteristics. Too often, however, the window for processing these formulations is undesirably narrow. Other viscoelastic foam formulations and processing techniques are disclosed in U.S. Pat. No. 6,391,935, U.S. Pat. No. 6,586,485. U.S. Pat. No. 6,734,220 and US 20050210595, each of which is incorporated herein by reference.

Commercially, water-blown flexible polyurethane foams are produced by both molded and free-rise (slab foam) processes. Conventional foam is most frequently made using the free-rise process. HR foam often is made using closed molds. Slab foams are generally produced more or less continuously by the free-rise process in large buns which, after curing, are sliced or otherwise formed into useful shapes. For example, carpet underlayment is sliced from large buns of polyurethane foam. Molding is typically utilized to produce, in what is essentially a batchwise process, an article in essentially its final dimensions. Automotive seating and some furniture cushions are examples of employment of the molding process. Slab foam buns produced using the free-rise process tend to be much larger than molded foams. While molded foam objects are normally less than about ten cubic feet in volume, slab foam buns are rarely less than 50 cubic feet in volume.

Each process has its advantages and disadvantages, and the impact of increasing water content to effect a decrease in density may be different in each. However, it is generally considered unacceptable if a decrease in density is associated with a substantial increase in rigidity. This is because while lower densities are generally desirable, if the means used to achieve this result produce an increase in the rigidity of the final foam, the foam will be considered not acceptable or at least of a lower quality/lower value. This is because rigidity is contrary to the intended purpose of such foams for the primary use as seat cushions, mattresses, sofa cushions, carpet underlayment and the like.

In general, the use of water to improve (ie., lower) the density of open cell, flexible foam is not a viable option beyond a certain point because it tends to cause other problems with the foam, such as an unacceptable increase in rigidity. Furthermore, by using additional water to blow a foam with decreased density can cause foam over-heating and significantly increases the hazard of fire, especially in slab foams because of the large volume of foam being produced. The hazard of fire is diminished when producing molded foam due to the small volume of the articles produced which facilitates their rapid cooling. In both cases, however, use of increased water can result in other problems, such as foam splitting, i.e. sizeable openings or voids in either or both the surface and interior of the foam.

It has been suggested that other, inert blowing agents may be used in addition to water in the formation of flexible foams. See for example U.S. Pat. No. 7,268,170. The '170 patent discloses that such other blowing agents can include halogenated hydrocarbons, liquid carbon dioxide, low boiling solvents such as, for example, pentane, and other known blowing agents. However, there is no indication that a careful selection from among this large group of possible blowing agents can be used in conjunction with water to achieve a reduction in foam density while maintaining one or more of the other important foam properties, such as IFD 25%, IFD 65%, tensile strength and elongation, compression set, and preferably all of these, at acceptable levels. Applicants have found that a careful selection of certain halogenated hydrocarbons for use in combination with water as a blowing agent is capable of achieving this and/or other advantageous, highly desirable and unexpected results, as explained hereinafter.

### SUMMARY OF THE INVENTION

The present invention relates to novel open-cell flexible thermoset foams, to composition and methods for forming such foams and to articles formed from such foams. The invention involves the use of foamable compositions which comprise water blowing agent and certain organic, inert co-blowing agents, including certain HFC, HFO and/or HFCO compounds, to form foamable compositions that have several unexpected advantages in terms of processing of the foam and the resultant foam properties. As used in the context of blowing agent, the term “inert” means that the blowing agent acts principally, and preferably essentially entirely, as a physical blowing agent (as opposed to a chemical blowing agent).

In certain highly preferred embodiments, the present invention provides a method of forming a flexible, open cell foam comprising: (a) providing a foamable, thermosetting composition capable of forming an open-cell, flexible foam, said composition comprising (i) one or more components capable of forming a thermoset matrix, preferably a polyurethane matrix; and (ii) a blowing agent for forming open cells in said matrix, said blowing agent comprising, preferably comprising at least 75% by weight of, more preferably comprising at least about 85′%, in certain embodiments consisting essentially of, and in certain embodiments consisting of, a combination of water and a co-blowing agent selected from the group consisting of trans-1-chloro-3,3,3-trifluoropropene (HFCO-1233zd(E)), 1,1,1,3,3-pentafluoropropane (HFC-245fa); 1,1,1,3,3-pentafluorobutane (365mfc), and blends consisting essentially of at least about 80% of HFC-365mfc and 1,1,1,2,3,3,3-heptafluoropropane (227ea), at least one compound of the Formula I (including 1,1,1,4,4,4-hexafluoro-2-butene (CF3CH═CHCF3, HFO-1336mzz) and combinations of any two or more of these; and (b) forming from said foamable composition a flexible foam comprising a matrix comprising thermoset polymer and a plurality of open cells in said matrix.

The at least one compound of Formula I is:

CF3CX═CHRa Formula I

where X is H or F and Ra is CF3CF2, CF3 or Cl.

In certain preferred embodiments the compound of Formula I is selected from compounds in which: (i) when X is F, then Ra is Cl; (ii) when Ra is CF3CF2 or Cl, then the compound of formula CF3CX═CHRa is the E configurational isomer, and (iii) when Ra is CF3, then the compound of formula CF3CX═CHRa is the Z configurational isomer.

In one preferred embodiment, the compound of Formula I comprises, and in certain embodiments consists essentially of or consists of, 1,1,1,4,4,4-hexafluoro-2-butene (CF3CH═CHCF3, HFO-1336mzz).

In another preferred the compound of Formula I comprises, and in certain embodiments consists essentially of or consists of 1,1,1,4,4,5,5,5-octafluoro-2-pentene (CF3CH═CHCF2CF3, HFO-1438mzz), preferably E-HFO-1438mzz.

In another preferred the compound of Formula I comprises, and in certain embodiments consists essentially of or consists of 3,3,4,4,5,5,5-heptafluoro-1-pentene (CF3CF2CF2CH═CH2 HFO-1447fz.

In certain preferred embodiments, the relative amounts of said water to said co-blowing agent(s) is effective to such that said methods: (1) produce a foam having a substantial density reduction in free-rise density compared to the same method but in which the co-blowing agent is not present; and/or (2) said providing step, especially and preferably in methods of forming molded flexible foam, utilizes a substantially reduced amount of foamable composition compared to the same method but in which the co-blowing agent is not present. In highly preferred embodiments, the substantial density reduction and/or foamable composition reduction is achieved while providing one or more of the following properties, and preferably at least any two of the following properties, and more preferably any three of the following properties, in a substantially acceptable value:

(a) IFD 25%

(b) IFD 65%

(c) comfort factor

(d) compression set

(e) resilience.

As used herein the term “substantial density reduction” means a reduction in density of at least 5% relative to the density of the same foam produced without the co-blowing agent.

As used herein the term “substantially reduced amount of foamable composition” means at least about 5% less foamable composition relative to the amount of foamable composition needed to form the article in the absence of said co-blowing agent.

It is contemplated that the present invention can be used to advantage in many types and varieties of flexible, open-cell foam. It is generally preferred, however, that the foams according to the present invention have a density of less than about 8 pounds per cubic foot (hereinafter “PCF”), more preferably less than about 7 PCF, and in certain preferred embodiments of less than about 6 PCF. For embodiments involving viscoelastic foam, the density of the foam is preferably be less than about 7 pounds per cubic foot, more preferably less than about 6 PCF, and in certain preferred embodiments is in the range of from about 3 PCF to about 7 PCF, more preferably in certain embodiments in the range of from about 4 PCF to about 6 PFC.

In certain embodiments, including particularly HR foam, the density of the foam is not greater than about 4.5 PCF (including particularly for MDI-based foam, and even more particularly molded MDI-based foam), more preferably not greater than about 3 PCF and in certain embodiments even more preferably not greater than 2.5 PCF (including particularly for MDI-based foam, and even more particularly molded MDI-based foam). The difficulty of achieving such density reductions according to prior art methods is believed to result, at least in part, from the large size of the hard segment polymer domains in MDI, relative to those in TDI, and also because of the lower NCO of MDI on a per pound basis.

In certain preferred embodiments, the present methods achieve a free-rise density reduction that is reduced at least about 5 relative percent, more preferably in certain embodiments at least about 8 relative percent, more preferably in certain embodiments at least about 10 relative percent, and even more preferably in certain embodiments at least about 12 relative percent. In certain highly preferred embodiments, including in each of the preferred embodiments described in the preceding sentence, the free-rise density reduction is achieved in an amount of up to about 15 relative percent. As used herein, the term “free-rise density reduction” means the density of foam made according the present methods and/or compositions as measured in free-rise of the type described in Example 1 hereof, in comparison to the density of the free-rise foam produced using the same method but without said co-blowing agent.

In preferred embodiments, and especially those embodiments relating to viscoelastic foam, the preferred density reductions are achieved while also achieving viscoelastic foam having low resilience, i.e., less than 15% as measured in the standard ball rebound test (ASTM D 3574-95, Test H), more preferably in certain embodiments the foams have resilience less than 10%; and even more preferably in certain embodiments the foams have a resilience of less than 5%. In addition, the preferred viscoelastic foams have a high degree of softness, as indicated by 25% IFD (indentation force deflection at 25% compression, ASTM D 3574, Test B1—values that are preferably less than about 22 lbs. (about 100 Newtons (N)). Preferred foams also have low compression sets. For example, preferred foams exhibit a 90% compression set value, (Ct (ASTM D 3574, Test D—70 C and ambient humidity), of less than about 15%, more preferably less than about 10% and even more preferably less than about 5%.

In certain preferred embodiments, and especially those embodiments relating to viscoelastic foam, each of the preferred reductions in density is achieved without decreasing the 90% compression set value, Ct (ASTM D 3574, Test D), by more than about 20 relative percent, more preferably not more than about 10 relative percent. In certain preferred embodiments, each of the preferred reductions in density is achieved without increasing the resilience as measured in the standard ball rebound test (ASTM D 3574-95, Test H) by more than about 20 relative percent, more preferably not more than about 10 relative percent.

In certain preferred embodiments, each of the preferred reductions in density is achieved without decreasing elongation as measured by ASTM D3574 Test E by more than about 25 relative percent, more preferably 20 relative percent, and even more preferably not more than about 10 relative percent. In certain preferred embodiments, each of the preferred reductions in density is achieved without degrading comfort factor by more than about 20 relative percent, more preferably not more than about 10 relative percent.

In certain preferred embodiments each of the preferred reductions in density is achieved without changing Indent Force Deflection (IFD) at 25% as measured by ASTM D3574 Test B1 by more than 25 relative percent, more preferably 20 relative percent, and even more preferably by more than 10 relative percent. In certain preferred embodiments each of the preferred reductions in density is achieved without changing Indent Force Deflection (IFD) at 65% as measured by ASTM D3574 Test B1 by more than 25 relative percent, more preferably 20 relative percent, and even more preferably by more than 10 relative percent.

In certain preferred embodiments especially for viscoelastic foam each of the preferred reductions in density is achieved while achieving in the foam a comfort factor (“CF” also sometimes referred to as “comfort value (CV)) of from about 1.25 to 2.8 for High Resilience HR foam. In certain embodiments, the CV is from about 2 to about 4, more preferably from about 2 to about 3, and even more preferably from about 2.2 to about 2.8. As used herein, the terms comfort factor and CF mean the ratio of IFD at 65% to the IFD at 25%. The CF is an important property indicator in certain applications, such as for example in automobile seat cushion manufacture, in that it is considered to represent the preferred balance of a foam that is soft but at the same time supportive.

In certain preferred embodiments each of the preferred reductions in density is achieved while achieving a foam with a 50% compression set at 70 C and ambient relative humidity (unless otherwise indicated herein, this is sometimes referred to simply as Compression Set), also known as “constant deflection compression set) as measured by ASTM D3574 Test D, of not greater than 15%, more preferably of not greater than 12%. Wet compression set 50 C at 95% RH is preferred to be less than 12% and more preferred to be less than 10%.

In certain highly preferred embodiments, each of the preferred reductions in density is achieved while simultaneously achieving the preferred values as mentioned herein of at least two, more preferably at least three, and in certain preferred embodiments preferably all of the following foam properties: IFD at 25%; IFD at 65%; elongation; compression set; and comfort factor.

In certain highly preferred embodiments, particularly those involving slab foam and even more preferably TDI-based or TDI/MDI based slab foam, each of the preferred reductions in density is achieved while simultaneously achieving a reduction of the exotherm associated with the process of producing the foam, preferably in certain embodiments by at least about 10, and preferably from about 10 to about 20 relative percent.

The present invention also provides in certain embodiments foamable compositions comprising (a) one or more components capable of forming a thermoset matrix, preferably a polyurethane matrix; and (b) a blowing agent for forming open cells in said matrix, said blowing agent comprising, and in certain embodiments consisting essentially of, water and a co-blowing agent selected from the group consisting of trans-1-chloro-3,3,3-trifluoropropene (HFCO-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), a compound of Formula I wherein said compound includes at least one of cted from HFO-1336mzz, HFO-1438mzz (preferably E-HFO-1438mzz) and HFO-1447fz and combinations of any two or more of these.

The present invention also provides in certain embodiments a blowing agent composition for use in forming a flexible, open-cell thermoset foam, preferably a polyurethane foam, said blowing agent composition comprising, and in certain embodiments consisting essentially of, water and a co-blowing agent selected from the group consisting of trans-1-chloro-3,3,3-trifluoropropene (HFCO-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), comprising a compound of Formula I wherein said compound includes at least one of cted from HFO-1336mzz, HFO-1438mzz (preferably E-HFO-1438mzz) and HFO-1447fz and combinations of any two or more of these.

One advantage that can be achieved in accordance with the present invention is the ability to form a low density, open-cell polyurethane foam having desirable physical properties, and in certain embodiments one or more properties (including the properties identified above) that are approximately as good as or better than foams made according to prior methods and compositions, and at the same time achieving a substantial advantage in raw material usage (e.g., polyurethane), preferably at least about 5%, more preferably at least about 10%, and in certain embodiments about 12%, compared to prior methods and compositions.

### DETAILED DESCRIPTION OF PREFERRED EMBODIMENTS

In general the present invention is adaptable for use in connection with either the slabstock method and to foamable compositions for use with the slabstock method, or the molding method of forming flexible polyurethane foams, and even more preferably in certain embodiments cold cure molding of flexible, open cell foam and to foamable compositions for use with the molding method. Preferably, the foams of the present invention are polyurethane foams. As used herein, the terms “polyurethane foam” generally refers to cellular products as obtained by reacting polyisocyanates with one or more isocyanate-reactive hydrogen containing compounds, in the presence of a blowing agent, and in particular includes cellular products obtained with water as reactive or chemical blowing agent (involving a reaction of water with isocyanate groups yielding urea linkages and carbon dioxide). The term “polyurethane foamable compositions” refers to compositions capable of being formed into a polyurethane foam.

As used herein, the term “flexible polyurethane foam” refers to cellular products which have a substantial proportion of open cells, and even more preferably consists essentially of open cells, and which exhibit substantial shape recovery after deformation.

The preferred polyurethane foams comprise the reaction product of an aromatic polyisocyanate component and an isocyanate-reactive component, preferably comprising one or more hydroxyl functional materials, including preferably polyoxyalkylene polyether polyols. In general, the reaction mixture preferably includes one or more catalysts, one or more surfactants and a blowing agent component

FOAMABLE COMPOSITIONS For both slabstock and molded methods, the preferred foamable compositions and foams are polyurethane-based and will generally include the following components:

A) one or more polyisocyanates;

B) one or more isocyanate-reactive hydrogen containing compounds;

C) blowing agent;

D) catalyst;

E) surfactant;

F) foam modifier;

G) other additives.

In general, it is contemplated that those skilled in the art will be able to select and adjust the type and amount of each of these components in view of the teachings contained herein to achieve advantageous foam, formable compositions and methods of the present invention, and all such selections and adjustments are within broad scope of the present invention. According to preferred aspects of the invention, the materials and amounts described below have certain advantages.

A. Isocyanates

Those skilled in the art will appreciate that the type and amount of isocyanate can vary widely depending on many factors, including whether the foamable composition is to be used in slabstock methods or molding methods, and the particular requirements of the methods involved and the expected end-use for the foam being formed.

Although many types of isocyanates are adaptable for use, in general, it is contemplated that the preferred compositions will comprise one or more aromatic polyisocyanate components, including preferably components based on MDI (diphenylmethane diisocyanate) c. TDI (toluene diisocyanate), mixtures of polymeric MDI and TDI, and modified versions of these, and combinations of these.

The terms “polymethylene polyphenylene polyisocyanates” and “MDI” are used herein to refer to polyisocyanates selected from diphenylmethane diisocyanate isomers, polyphenyl polymethylene polyisocyanates and derivatives thereof bearing at least two isocyanate groups and containing carbodiimide groups, uretonimine groups, isocyanurate groups, urethane groups, allophanate groups, urea groups or biuret groups. They are obtainable, for example, by condensing aniline with formaldehyde, followed by phosgenation, which process yields what is called crude MDI, by fractionation of said crude MDI, which process yields pure MDI and polymeric MDI, and by autocondensation of crude, pure or polymeric MDI, or reaction of excess of crude, pure or polymeric MDI with polyols or polyamines, which processes yield modified MDI, containing carbodiimide, uretonimine, isocyanurate, urethane, allophanate, urea or biuret groups. Examples of MDI that are adaptable for use in accordance with the present invention are provided in U.S. Pat. No. 5,399,594, which is incorporated herein by reference.

It is contemplated that in certain embodiments the isocyanate can include, 2,4′-diphenylmethane diisocyanate (2,4′-MDI), 4,4′-diphenylmethane diisocyanate (4,4′-MDI), H12MDI (hydrogenated MDI).

The term “TDI” is used herein to toluene diisocyanates general and is intended to include but is not limited to 2,4-toluene diisocyanate (2,4-TDI), 2,6-tolylene diisocyanate (2,6-TDI), H6TDI (hydrogenated TDI), and combinations of these.

It is also contemplate that the isocyanate in general, and the MDI and the TDI components in particular, can include materials known as urethane prepolymers obtained by the pre-reaction/reacting such isocyanate compounds with one or more of the polyol compounds, including those described below.

Other isocyantes can be used instead of or in addition to one or more of the MDI components or TDI components, including 1,4-phenylene diisocyanate, xylylene diisocyanate (XDI), tetramethylxylylene diisocyanate (TMXDI), tolidine diisocyanate (TODI), and 1,5-naphthalene diisocyanate (NDI); aliphatic polyisocyanates such as hexamethylene diisocyanate (HDI), trimethylhexamethylene diisocyanate (TMHDI), lysine diisocyanate, and norbornane diisocyanate methyl (NBDI); alicyclic polyisocyanates such as transcyclohexane-1,4-diisocyanate, isophorone diisocyanate (IPDI), H6XDI (hydrogenated XDI).

Once again, the type and the amount of the various isocyanate components to be included can be determined by those skilled in the art in view of the teaching contained herein.

It is also contemplated that the amount of the isocyanate relative to the other components of the foamable composition according to the present invention can vary widely within the scope hereof, and all such relative amounts are within the broad scope of the invention. In general, however, it preferred that the amount of isocyanate is selected relative to the amount of the one or more isocyanate-reactive hydrogen containing compounds so as to obtain an Index of from about 75 to about 115, more preferably from about 80 to about 110 and even more preferably from about 85 to 105. The term “Index” is used by those skilled in the art as a shortcut term to indicate the ratio of NCO (isocyanate) groups to OH, water and other isocyanate-reactive groups in the foam. For instance an Index of 85 indicates a ratio of 0.85, while an Index of 105 indicates a ratio of 1.05.

In preferred embodiments, the isocyanate has an NCO percentage that can vary widely within the scope hereof. In certain preferred embodiments, the NCO of the isocyanate in the foamable composition is from about 20 to about 32%, more preferably from about 25 to about 32, and the NCO in the foam is from 12 to about 29%.

B. Isocyanate-Reactive Hydrogen Containing Compounds

As used herein, the term “isocyanate-reactive hydrogen containing compounds” or “isocyanate-reactive compounds” includes polyols as well as polyamines and combinations of these. The term “polyurethane foam” is thus intended also to include products which comprise urethane linkages together with urea linkages and even products which essentially comprise urea linkages with few or no urethane linkages. The isocyanate-reactive hydrogen containing compounds preferably comprising one or more hydroxyl functional materials, including preferably polyoxyalkylene polyether polyols

Once again, it is contemplated that the type and amount of isocyanate-reactive hydrogen containing compounds, including the polyol, can be readily selected for use with the present invention in view of the teachings contained herein. In certain preferred embodiments, polyol is used and is preferably selected from polyether polyol, a polyester polyol, or a polyol chain extender.

In highly preferred embodiments the isocyanate-reactive hydrogen containing compounds comprise, more preferably comprise in major proportion, polyether polyol(s). Representative examples of polyether polyols are polyether diols such as polypropylene glycol, polyethylene glycol and polytetramethylene glycol; polyether triols such as glycerol triols; polyether tetrols and pentols such as aliphatic amine tetrols and aromatic amine tetrols; polyether octols such as sucrose octol; and others such as sorbitol, trimethylol propane, and pentaerythritol. Of course, any combination of any two or more of these may be used and combined or not with other isocyanate-reactive hydrogen containing compounds.

In preferred embodiments the isocyanate-reactive component comprises a polyol, and even more preferably a blend of polyols. In certain preferred embodiments, the polyol comprises polyether polyol (such as may be formed by reacting polypropylene oxide and glycerol), and even more preferably in certain embodiments a polyether polyol having a molecular weight (MW) of from about 2,000 to about 10.000 preferably 3000 to 8000 and most preferably 4500 to 7500. With respect to functionality, it is preferred that the polyol component has a functionality of from about 1 to about 6, more preferably from about 2 to about 5, and even more preferably from about 2 to about 4.

C. Blowing Agent

Applicants have found that unexpected by highly desirable advantage can be achieved by the use of blowing agent, especially in combination with the other preferred aspects of the invention, comprising: (a) at least one chemical blowing agent, preferably water; and (b) at least one physical blowing agent, which preferably comprises, and in certain embodiments consisting essentially of at least one co-blowing agent selected from the group consisting of trans-1-chloro-3,3,3-trifluoropropene (HFCO-1233zd(E)); 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea),), at least one compound of the Formula I (including 1,1,1,4,4,4-hexafluoro-2-butene (CF3CH═CHCF3, HFO-1336mzz) and combinations of any two or more of these.

In general it is preferred that the blowing agent component is present in the reaction mixture in an amount of from about 0.5% to about 10% by weight based on the total weight of the reaction mixture (including the aromatic polyisocyanate component and the isocyanate-reactive component), and more preferably from about 1% to about 8% by weight, and even more preferably from about 1.3 to about 4% by weight.

In certain embodiments the blowing agent preferably comprises from about 55 mol % to about 98 mol % of chemical or reactive blowing agent, preferably consisting essentially of water, and from about 2 mol % to about 45 mol % by of a physical blowing agent. In preferred embodiments the physical blowing agent is selected from the group consisting of trans-1-chloro-3,3,3-trifluoropropene (HFCO-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), and combinations of any two or more of these. In certain preferred embodiments, the chemical or reactive blowing agent, preferably water, is present in amounts of from about 55 to about 98 mol %, more preferably from about 70 to about 96 mol %, and even more preferably in certain embodiments in amounts for from about 80 mol % to about 95 mol % based on the total blowing agent components, and the physical blowing agent, preferably selected from the group as identified herein, is present in an amount of from about 2 mol % to about 50 mol %, more preferably from 2 to about 30 mol % and even more preferably in amounts of from about 3 mol % to about 20 mol % of based on the total blowing agent components. In certain embodiments the chemical or reactive blowing agent, preferably water, is present in amounts of from about 85 mol % to about 95 mol % based on the total blowing agent components, and the physical blowing agent, preferably selected from the group as identified herein, is present in an amount of from about 5 mol % to about 15 mol % of the total blowing agent components.

D. Foam Modifying Agent

Applicants have found that certain of the physical properties of the foams formed according to the present invention can be unexpectedly be maintained and/or enhanced by incorporation into the foamable composition one or more foam modifying agents. More specifically, applicants have found that in certain embodiments a level of density reduction is desired, and can be achieved according to the present invention by use of the blowing agent as described herein, but one or more foam properties are altered in a manner that is undesirable and/or unacceptable for certain applications. The properties that can be negatively impacted in such situations include (a) IFD at 25%; (b) IFD at 65%; (c) comfort factor; (d) compression set; and (e) resilience. Applicants have found that including certain select compounds or combinations of compounds (referred to herein for convenience but not by way of limitation) a “foam modifying agent” of the present invention in the present compositions can interact in an unexpected manner with the other components of the composition during the foaming process to result in an improvement in one or more, and preferably at least two of these properties.

Applicants have found that certain diol, triols and combinations of these are capable of acting as effective reinforcing agents according to the preferred aspects of the present invention. For foaming modifying agents comprising diols, the molecular weight of the diol is preferably from about 60 to about 250, more preferably about 85 to about 180. In particularly preferred embodiments diol is 1,4 butane diol. For foaming modifying agents comprising triols, the molecular weight of the triol is preferably from about 70 to about 5000, more preferably about 80 to about 265. In particularly preferred embodiments the triol has at least a secondary and more preferably a tertiary amine. In highly preferred embodiments, the triol is selected from glycerol, triisopropanolamine, and polyether triol having a molecular weight of from about 250 to 275, and preferably of about 265. In preferred embodiments, the amount of the foam modifying agent is present in the composition in an amount of from greater than about 0 to about 1%.

E) Catalysts

In preferred embodiments the catalysts comprise, and in certain embodiments consist in major proportion of, tertiary amines containing hydroxyl, primary or secondary amines. Preferably the amine catalyst such as TEDA and Dabco BL-11 are used, in addition low-emissive or even “non-emissive” catalyst as would typically be used in open-cell flexible foam, and even more preferably molded foam used for auto or other transportation seat foam. Examples of catalyst that may be useful according to the present invention are: Dabco NE300, NE600, NE310, Polycat 140, NE1070 and NE1190, Jeffcat ZF-10, triethylene diamine, and 2-(2 dimethylaminoethyloxy)-N,N-dimethylethanamine (Dabco Bl-11). The catalyst may also comprise in certain embodiments other catalytic materials that are known for use in minor amounts in flexible foam applications, including organo-metallic catalysts used for rigid foam would be included such as those based on tin, zinc, and bismuth.

### Foaming Methods

A) Molding Methods

It is contemplated that all known methods of forming open-cell, flexible polyurethane foam are adaptable for use in accordance with the present methods, and all such methods are within the broad scope of the present invention. In general, the molding aspects of the present invention include the step of providing a foamable composition, preferably by mixing the polyol components and the isocyanate components to form a reactive mixture, introducing the foamable composition into the mold, which is preferably a heated mold, and closing the mold. In preferred embodiments, the foamable composition sufficiently reactive to substantially fill the mold in a time period that is greater than about 2 seconds, and even more preferably in a time period greater than about 3 seconds and even more preferably in a time period that is greater than about 4 seconds. In certain embodiments, the time required to fill the mold is greater than one or more of preferred minimum mold-tile time but less than about 15 seconds, more preferably less than about 10 seconds, and even more preferably less than about 8 seconds.

In preferred embodiments the mold is a heated mold heated to a temperature of at least about 120 C, and even more preferably from about 120 F to about 140 F.

In preferred embodiments, the amount of foamable composition introduced to the mold creates an overpack of from about 0% to about 20%. As used herein, the term 0% overpack means introducing into the mold the theoretical amount of foamable composition that would be needed to fill the foam volume based on the free-rise density of the foamable composition. Other overpack values are based upon 0% overpack as this calculated.

Applicants have found that in certain preferred embodiments unexpected advantage can be achieved by conducting the molding step by using an overpack that is at least about 5%, more preferably at least about 10%, and even more preferably at least about 15%. More particularly, applicants have found that selection of relatively high overpack, including preferably an overpack value above about 10%, more preferably above about 12% and even more preferably above about 13%, can cause a substantial reduction in the compression set of the foam (whether the foam is MDI based, TDI based or a mixture of MDI and TDI) compared to a lower overpack value. Applicants have found that is unexpected advantage is desirable because in certain embodiments the use of the preferred co-blowing agent to achieve the desired free-rise density reduction can cause an unwanted, and in certain cases, an unacceptable increase in compression set. This result is especially unexpected and advantageous in connection with Wet Compression Set (at 50 C and 50% deflection), which in preferred embodiments of the present invention is less than 15%, more preferably less than 13%, and in highly preferred embodiments less than 10%.

B) Slab Foam Methods

According to preferred embodiments, the present invention provides method of forming open-cell, flexible slab foam. It is contemplated that all known methods of forming open-cell, flexible polyurethane slab foam are adaptable for use in accordance with the present methods, and all such methods are within the broad scope of the present invention. In general the slab foam method aspects of the present invention include the step of providing a foamable composition according to the present invention onto a conveyor or other appropriate substrate and allowing the foam to rise under the desired conditions for the desired period of time.

Applicants have found that one unexpected advantage of the present invention is that use of a blowing agent to form a slab foam not only provides an advantageous density reduction, in preferred embodiments it also decreases the exotherm associated with the foaming process. Reduction of this exotherm, preferably by at least about 2%, more preferably at least about 3% and most preferably at least about 4% has many advantages in connection with slab foam processing. For example, such a reduction in exotherm may permit the use of different amounts or types of catalyst in foamable composition, which can have substantial advantages. It can also serve to avoid the problems with high exotherms as described herein before. Other advantages of methods involving such a reduction in exotherm will be understood by those skilled in the art.

It is generally preferred that slab foam formulations according to the present invention are TDI-based foams, although MDI-based foam and MDI/TDI combination foams can also realize advantage in connection with the preferred slab foam aspects of the present invention. For those embodiments in which combination of MDI and TDI are used, all ratios of these components are contemplated. However, it is preferred that when TDI:MDI combinations are used that the weight ratio in the formulation is from about 99.9:0.1 to about 50:50, more preferably 99.8:0.1 to about 50:40 and even more preferably 99.8:0.1 to about 80:20.

According to one aspect of the present invention, it is believed that a most advantageous use of the present invention can be achieved in connection with methods of forming open cell flexible foam products using the slab foam methods, and in particular with such methods for producing viscoelastic flexible foams having a density of less than or equal to about 7 PCF, preferably less than or equal to 6 PCF, more preferably less than about 5 PCF, and even more preferably in certain embodiments less than about 4 PCF. Furthermore, it is preferred in certain embodiments that the viscoelastic foams produced according to the present invention have a Compression Set of not greater than 15%, more preferably of not greater than 12%, even more preferably of not greater than 10%, and most preferably in certain embodiments not greater than about 8%. It is also preferred in certain embodiments that the viscoelastic foam of the present invention has a comfort factor of from about 2 to about 4, more preferably from about 2 to about 3, and even more preferably from about 2.2 to about 2.8.

### Articles

It is contemplated that any of the articles currently formed from flexible open-cell foam can be formed form the foams of the present invention. It is believed however that the molded foam formulations and the molding methods of the present invention are well suited to form automotive foams, including seat cushion foams, seat back foams, arm rest, dashboard, head rest, and head rest foams, as well as furniture foams, including particular office furniture.

It is believed however that the slab foam formulations and the slab forming methods of the present invention are well suited to form mattress foams, furniture foams, including sofas and large chairs and in airline seat foam.

### EXAMPLES

In Examples 1-7 and C1-C8 which follow, bench scale foams are prepared. The foamable compositions are all prepared using as the isocyanate component the MDI LUPRINATE M10 ((5 gal=31.8% NCO) and ingredients of the polyol master batch as listed in Table A below, unless specifically indicated herein.

TABLE A

| | MATERIAL |
|---|---|
| COMPONENT | |
| POLYOL A | BASF Pluracol 1026 |
| POLYOL B | BASF Pluracol FF1528 |
| POLYOL C | BASF Pluracol 816 |
| SURFACTANT A | Dabco DC5043 |
| SURFACTANT B | Dabco DC2525 |
| ISOCYANATE A | Lupranate M10 (MDI) |
| BLOWING AGENTS | |
| | WATER (Deionized) |
| | HFO-1336mzz |
| | E-HFO-1438mzz |
| | HFO-1447fz |
| FOAM MODIFIERS | |
| | Dipropylene Glycol |
| CATALYST A | DMEA |
| CATALYST B | Dabco 2040 |
| CATALYST C | JeffCat ZF10 |
| FOAM ADDITIVE A | Glycerol |
| FOAM ADDITIVE B | 1,4 Butane Diol |

A polyol master batch is created by introducing the Polyols A-C and Surfactants A and B into a container. These materials are then mixed until uniform. Then the foam modifier (dipropylene glycol), the water, and the catalyst are added. Mixing is resumed for several minutes to produce the polyol master batch as indicated in Control Table 1 below. To produce the foam, 220.7 grams of the isocyanate and 400 grams of the polyol master batch (as modified according to each of the examples) are mixed together for about 6 seconds at 6000 RPM to simulate the results of a machine molding process. Then the combined ingredients which form a foamable, reactive composition are poured into a 12×12×5 inch box and allowed to foam. The reaction profile is monitored until the surface is tack-free. The foam is allowed to cure at ambient conditions for about 20 minutes and then is crushed to open many, and preferably substantially all, of any remaining closed cells. After crushing, the foam is allowed to cure at ambient conditions for about 24 hours. Indications of foam shrinkage are noted after this period and then the foam is cut 12×12×4″ for physical property measurements.

### Control Number 1

An open cell, flexible polyurethane foam was formed to be used as a control for Examples 1-4 and C1-C4 using the following 100 index foam formulation:

CONTROL TABLE 1
Polyol Master Batch

| | | WT % | | |
|---|---|---|---|---|
| | | IN THE | PARTS | |
| | | MASTER | PER | |
| | | BATCH | HUN- | MOL % |
| | WEIGHT, | FORMU- | DRED | BLOWING |
| | grams | LATION | POLYOL | AGENT |
| COMPONENT | | | | |
| POLYOL A | 700 | 81.02 | 85.59 | NA |
| POLYOL B | 45 | 5.21 | 5.52 | NA |
| POLYOL C | 70 | 8.1 | 8.59 | NA |
| SURFACTANT A | 2 | 0.23 | 0.25 | |
| SURFACTANT B | 6 | 0.69 | 0.74 | NA |
| FOAM MODIFIER | 6.75 | 0.78 | 0.83 | |
| BLOWING AGENTS | | | | |
| WATER | 27.5 | 3.18 | 3.37 | 100 |
| CATALYST A | 1.78 | 0.21 | 0.22 | NA |
| CATALYST B | 1.04 | .012 | 0.13 | NA |
| CATALYST B | 3.89 | 0.45 | 0.48 | NA |
| PHYSICAL | 0 | 0 | 0 | NA |
| PROPERTY | | | | |
| MODIFIER | | | | |
| TOTAL | 863.95 | 100.00 | 106.01 | 100 |

After being processed as indicated above to form a first foam, the procedure is repeated identically to form a second foam and a third foam. The foams so produced are tested and found to have the average following physical properties.

### Density (PCF)—2.23

### IFD 25%—125

### IFD 65%—330

### CV—2.64

Tensile Strength, psi—15.37

### Elongation—88.8

### Constant Deflection Compression (at 45-50′C)—13.97

### Example 1A

Open cell, flexible polyurethane foams are formed using the same procedures and materials indicated above in connection with the control, except that four samples are made and for each sample the blowing agent is modified to include a co-blowing agent HFO-1336mzz in an amount such that the total blowing agent has the following concentrations, with the total weight of the water in the formulation remaining unchanged:

| BLOWING AGENT | Wt % | Mol % |
|---|---|---|
| WATER | 44.92 | 88.14 |
| HFO - 1336mfc | 55.08 | 11.86 |

The foams so produced are tested and found to have the following average physical properties and comparisons to the control:

| | CONTROL | EXAMPLE 1 | % CHANGE |
|---|---|---|---|
| DENSITY, PCF | 2.2 | 1.9 | −12 |
| CONSTANT | 14. | 12.2 | −13 |
| DEFLECTION | | | |
| COMPRESSION | | | |
| (at 45-50° C.) | | | |
| IFD 25% | 125 | 101 | −19 |
| IFD 65% | 330 | 250 | −24 |
| Tensile Strength, psi | 15 | 14 | −11 |
| Elongation | 88.8 | 101.9 | 14.75 |

### Example 2

Open cell, flexible polyurethane foams were formed using the same procedures and materials indicated above in connection with the control, except that five samples were made and for each sample the blowing agent was modified to include as a co-blowing agent HFC-1447 in an amount such that the HFC-1447 was present in the same molar amount as the co-blowing agent in Example 1, as indicated below:

| BLOWING AGENT | Wt % | Mol % |
|---|---|---|
| WATER | 40.56 | 88.14 |
| HFC-1447 | 59.44 | 11.86 |

The foams so produced are tested and found to have physical properties and comparisons to the control that are acceptable but with a substantially reduce density.

### Example 3

Open cell, flexible polyurethane foams are formed using the same procedures and materials indicated above in connection with the control, except that three samples are made and for each sample the blowing agent is modified to include as a co-blowing agent E-HFO-1438mzz and in an amount such that the co-blowing agent is present in the same molar amount as the co-blowing agent in Example 1, as indicated below:

| BLOWING AGENT | Wt % | Mol % |
|---|---|---|
| WATER | 38.47 | 88.14 |
| E-HFO-1438mzz | 61.53 | 11.86 |

The foams so produced are tested and found to have physical properties and comparisons to the control that are acceptable but with a substantially reduce density.

### Comparative Example C1

Open cell, flexible polyurethane foams were formed using the same procedures and materials indicated above in connection with Examples 1-3, except that two samples were made and for each sample the blowing agent included instead of a co-blowing agent an increased amount of water such that the same total moles of water were present in the composition as the total moles blowing agent present in Examples 1-3. Thus, the comparative formulation included 48.92 grams of water compared to 27.5 grams in the control.

The foams so produced are tested and found to have the following average physical properties and comparisons to the control:

| | CONTROL | EXAMPLE C1 | % CHANGE |
|---|---|---|---|
| DENSITY, PCF | 2.23 | 1.99 | −10.9 |
| CONSTANT | 13.969 | 22.058 | 57.91 |
| DEFLECTION | | | |
| COMPRESSION | | | |
| (at 45-50° C.) | | | |

### Comparative Example C2

Open cell, flexible polyurethane foams were formed using the same procedures and materials indicated above in connection with Examples 1-3, except that two samples were made and for each sample the blowing agent included as the co-blowing agent acetone and in an amount such that the co-blowing agent was present in the same molar amount as the co-blowing agent in Example 1, as indicated below:

| BLOWING AGENT | Wt % | Mol % |
|---|---|---|
| WATER | 69.73 | 88.14 |
| Acetone | 30.27 | 11.86 |

The foams so produced are tested and found to have the following average physical properties and comparisons to the control:

| | CONTROL | EXAMPLE C2 | % CHANGE |
|---|---|---|---|
| DENSITY, PCF | 2.23 | 2.1 | −5.8 |

### Comparative Example C3

Open cell, flexible polyurethane foams were formed using the same procedures and materials indicated above in connection with Examples 1-3, except that two samples were made and for each sample the blowing agent included as the co-blowing agent dimethoxymethane and in an amount such that the co-blowing agent was present in the same molar amount as the co-blowing agents in Examples 1-3, as indicated below:

| BLOWING AGENT | Wt % | Mol % |
|---|---|---|
| WATER | 70.89 | 88.14 |
| Dimethoxymethane | 9.54 | 11.86 |

The foams so produced are tested and found to have the following average physical properties and comparisons to the control:

| | CONTROL | EXAMPLE C4 | % CHANGE |
|---|---|---|---|
| DENSITY, PCF | 2.23 | 2.18 | −2.2 |

### Comparative Example C4

Open cell, flexible polyurethane foams were formed using the same procedures and materials indicated above in connection with Examples 1-3, except that two samples were made and for each sample the blowing agent included as the co-blowing agent methyl formate and in an amount such that the co-blowing agent was present in the same molar amount as the co-blowing agents in Examples 1-3, as indicated below:

| BLOWING AGENT | Wt % | Mol % |
|---|---|---|
| WATER | 69.01 | 88.14 |
| Methy formate | 30.99 | 11.86 |

The foams so produced are tested and found to have the following average physical properties and comparisons to the control:

| | CONTROL | EXAMPLE C4 | % CHANGE |
|---|---|---|---|
| DENSITY, PCF | 2.23 | 2.15 | −3.8 |

### Example 4

Open cell, flexible polyurethane foams are formed using the same procedures and materials indicated above in connection with Example 1 (the blowing agent consisting of water and HFO-1336mmz), except that a compound found to have the ability to enhance certain foam physical properties when used in accordance with the present invention, including but not limited to compression set, namely, 1,4 butane diol, was added in an amount of about (0.95 pphp).

The foams so produced are tested and found to have the following average physical properties and comparisons to the control:

| | CONTROL | EXAMPLE 4 | % CHANGE |
|---|---|---|---|
| DENSITY, PCF | 2.2 | 1.8 | −12 |
| IFD 25% | 125 | 121 | −3.2 |
| IFD 65% | 330 | 330 | 0 |
| Tensile Strength, psi | 15.4 | 14.3 | −7 |
| Elongation | 88.8 | 90.7 | 2.1 |

### Control Number 2

An open cell, flexible polyurethane foam was formed to be used as a control for Examples 5-8 and C5-C8 using the following 100 Index foam formulation:

CONTROL TABLE 2
Polyol Master Batch

| | | WT % | | |
|---|---|---|---|---|
| | | IN THE | PARTS | |
| | | MASTER | PER | MOL % |
| | | BATCH | HUN- | IN |
| | WEIGHT, | FORMU- | DRED | BLOWING |
| | grams | LATION | POLYOL | AGENT |
| COMPONENT | | | | |
| POLYOL A | 0 | 0 | 0 | NA |
| POLYOL B | 0 | 0 | 0 | NA |
| POLYOL C | 750 | 93.85 | 100 | NA |
| SURFACTANT A | 2 | 0.25 | 0.27 | |
| SURFACTANT B | 6 | 0.75 | 0.8 | NA |
| FOAM MODIFIER | 14 | 1.75 | 1.87 | |
| BLOWING AGENTS | | | | |
| WATER | 21 | 2.63 | 2.8 | 100 |
| CATALYST A | 1.64 | 0.21 | 0.22 | NA |
| CATALYST B | 0.96 | .012 | 0.13 | NA |
| CATALYST B | 3.58 | 0.45 | 0.48 | NA |
| PHYSICAL | 0 | | 0 | NA |
| PROPERTY | | | | |
| MODIFIER | | | | |
| TOTAL | 799.18 | 100.00 | 106.56 | 100 |

After being processed as indicated above to form a first foam, the procedure is repeated identically to form a second foam and a third foam. The foams so produced are tested and found to have the average following physical properties.

### Density (PCF)—2.54

### IFD 25%—157

### IFD 65%—360

### CV—2.31

Constant Deflection Compression (taken at 70° C.)—9.92

### Example 5

Open cell, flexible polyurethane foams are formed using the same procedures and materials indicated above in connection with the control, except that two samples are made and for each sample the blowing agent included as a co-blowing agent HFO-1336mzz in an amount such that the blowing agent had the following concentrations:

| BLOWING AGENT | Wt % | Mol % |
|---|---|---|
| WATER | 42.09 | 86.88 |
| HFO - 1336mzz | 57.91 | 13.12 |

The foams so produced are tested and found to have the following average physical properties and comparisons to the control:

| | CONTROL | EXAMPLE 5 | % CHANGE |
|---|---|---|---|
| DENSITY, PPCF | 2.5 | 2.2 | −13 |
| CONSTANT | 9.9 | 10.3 | 4 |
| DEFLECTION | | | |
| COMPRESSION | | | |
| (taken at 70° C.) | | | |
| IFD 25% | 160 | 120 | |
| IFD 65% | 360 | 260 | |
| CV | 2.3 | 2.25 | |

### Example 6

Open cell, flexible polyurethane foams are formed using the same procedures and materials indicated above in connection with the control, except that for each sample the blowing agent included as a co-blowing agent HFC-1447fz in an amount such that the HFC-1447fz is present in the same molar amount as the co-blowing agent in Example 5, as indicated below:

| BLOWING AGENT | Wt % | Mol % |
|---|---|---|
| WATER | 37.82 | 86.88 |
| HFC - 1447fz | 62.18 | 13.12 |

The foams so produced are tested and found to have acceptable physical properties, except with a substantially reduced density.

### Example 7

Open cell, flexible polyurethane foams are formed using the same procedures and materials indicated above in connection with the control, except that for each sample the blowing agent included as a co-blowing agent HFC-1438mmz in an amount such that the HFC-1438mmz is present in the same molar amount as the co-blowing agent in Example 5, as indicated below:

| BLOWING AGENT | Wt % | Mol % |
|---|---|---|
| WATER | 35.77 | 86.88 |
| HFC - 1447 | 64.23 | 13.12 |

The foams so produced are tested and found to have acceptable physical properties, except with a substantially reduced density.

### Comparative Example C5

Open cell, flexible polyurethane foams were formed using the same procedures and materials indicated above in connection with Examples 5-7, except that the blowing agent included as the co-blowing agent trans-1,3,3,3-tetrafluoroethylene (“trans-HFO-1234ze”) (added to the polyol master batch by incorporating it into the master batch as a solution with the polyol) and in an amount such that the co-blowing agent was present as indicated below:

| BLOWING AGENT | Wt % | Mol % |
|---|---|---|
| WATER | 55.08 | 88.6 |
| transHFO-1234ze | 44.92 | 11.4 |

The foams so produced are tested and found to have the following average physical properties and comparisons to the control:

| | CONTROL | EXAMPLE C3 | % CHANGE |
|---|---|---|---|
| DENSITY, PCF | 2.54 | 2.46 | −3.34 |

### Comparative Example C6

Open cell, flexible polyurethane foams were formed using the same procedures and materials indicated above in connection with Examples 5-7, except that for each sample the blowing agent included as the co-blowing agent acetone and in an amount such that the co-blowing agent was present in the same molar amount as the co-blowing agent in Example 5, as indicated below:

| BLOWING AGENT | Wt % | Mol % |
|---|---|---|
| WATER | 67.23 | 86.88 |
| Acetone | 32.77 | 13.12 |

The foams so produced are tested and found to have the following average physical properties and comparisons to the control:

| | CONTROL | EXAMPLE C6 | % CHANGE |
|---|---|---|---|
| DENSITY, PCF | 2.54 | 2.47 | −2.56 |
| CONSTANT | 9.92 | 9.97 | 0.5 |
| DEFLECTION | | | |
| COMPRESSION | | | |
| (taken at 70° C.) | | | |
| IFD 25% | 157 | 144 | |
| IFD 65% | 360 | 315 | |
| CV | 2.31 | 2.19 | |

### Comparative Example C7

Open cell, flexible polyurethane foams were formed using the same procedures and materials indicated above in connection with Examples 5-7, except that two samples were made and for each sample the blowing agent included as the co-blowing agent dimethoxymethane and in an amount such that the co-blowing agent was present in the same molar amount as the co-blowing agents in Examples 5-7, as indicated below:

| BLOWING AGENT | Wt % | Mol % |
|---|---|---|
| WATER | 61.02 | 86.88 |
| Dimethoxymethane | 38.98 | 13.12 |

The foams so produced are tested and found to have the following average physical properties and comparisons to the control:

| | CONTROL | EXAMPLE C7 | % CHANGE |
|---|---|---|---|
| DENSITY, PPCF | 2.54 | 2.49 | −1.97 |
| CONSTANT | 9.92 | 9.8 | −1 |
| DEFECTION | | | |
| COMPRESSION | | | |
| (taken at 70° C.) | | | |
| IFD 25% | 157 | 145 | |
| IFD 65% | 360 | 340 | |
| CV | 2.31 | 2.35 | |

### Comparative Example C8

Open cell, flexible polyurethane foams were formed using the same procedures and materials indicated above in connection with Examples 5-7, except that two samples were made and for each sample the blowing agent included as the co-blowing agent methyl formate and in an amount such that the co-blowing agent was present in the same molar amount as the co-blowing agents in Examples 5-7, as indicated below:

| BLOWING AGENT | Wt % | Mol % |
|---|---|---|
| WATER | 66.34 | 88.14 |
| Methy formate | 33.66 | 11.86 |

The foams so produced are tested and found to have the following average physical properties and comparisons to the control:

| | CONTROL | EXAMPLE C8 | % CHANGE |
|---|---|---|---|
| DENSITY, PCF | 2.54 | 2.51 | −1.18 |
| CONSTANT | 9.92 | 15.97 | 60.98 |
| DEFLECTION | | | |
| COMPRESSION | | | |
| (taken at 70° C.) | | | |
| IFD 25% | 157 | 145 | |
| IFD 65% | 360 | 344 | |
| CV | 2.31 | 2.37 | |

### Control Number 3

An open cell, flexible polyurethane foam is formed to be used as a control for Examples 8-11 using the same formulation as Control 1 except at a 90 index.
After being processed as indicated above to form a first foam, the procedure is repeated identically to form a second foam and a third foam. The foams so produced are tested and found to have the average following physical properties.

### Density (PCI)—2.48

### IFD 25%—129

### IFD 65%—314

### CV—2.43

Tensile Strength, psi—15.5

### Elongation—84.5

### Constant Deflection Compression (at 70° C.)—13.5

### Example 8

Open cell, flexible polyurethane foams are formed using the same procedures and materials indicated above in connection with Example 1 but using the foam formulation of Control Number 3 with the blowing agent modified as per Example 1.

The foams so produced are tested and found to have the following average physical properties and comparisons to the control:

| | CONTROL | EXAMPLE 8 | % CHANGE |
|---|---|---|---|
| DENSITY, PCF | 2.48 | 2.17 | −12 |
| IFD 25% | 129 | 109 | −16 |
| IFD 65% | 314 | 258 | −18 |
| Comfort | 2.43 | 2.37 | −2 |
| Tensile Strength, psi | 15.5 | 14.7 | −5 |
| Elongation | 84.5 | 91.3 | 8 |
| Compression (at | 13.5 | 11.9 | −12 |
| 70° C.) | | | |

### Example 9

Open cell, flexible polyurethane foams are formed using the same procedures and materials indicated above in connection with Example 1 but using the foam formulation of Control Number 3, except that a compound found to have the ability to enhance certain foam physical properties when used in accordance with the present invention, including but not limited to compression set and comfort factor, namely, glycerol is added in an amount of about 5% equivalent.

The foams so produced are tested and found to have the following average physical properties and comparisons to the control:

| | CONTROL | EXAMPLE 9 | % CHANGE |
|---|---|---|---|
| DENSITY, PCF | 2.48 | 2.15 | −13 |
| IFD 25% | 129 | 114 | −12 |
| IFD 65% | 314 | 283 | −10 |
| Comfort | 2.43 | 2.48 | 2 |
| Tensile Strength, psi | 15.5 | 19.1 | 24 |
| Elongation | 84.5 | 90.9 | 8 |
| Compression - 70° C. | 13.5 | 15.8 | 17 |

### Example 10

Open cell, flexible polyurethane foams are formed using the same procedures and materials indicated above in connection with Example 1 but using the foam formulation of Example 10, except that glycerol is added in an amount of about 7.5% equivalent.

The foams so produced are tested and found to have the following average physical properties and comparisons to the control:

| | CONTROL | EXAMPLE 10 | % CHANGE |
|---|---|---|---|
| DENSITY, PCF | 2.48 | 2.06 | −17 |
| IFD 25% | 129 | 112 | −13 |
| IFD 65% | 314 | 276 | −12 |
| Comfort | 2.43 | 2.46 | 1 |
| Tensile Strength, psi | 15.5 | 13.8 | −11 |
| Elongation | 84.5 | 74. | −12 |
| Compression (at | 13.5 | 16.8 | 24 |
| 70° C.) | | | |

### Example 11

Open cell, flexible polyurethane foams are formed using the same procedures and materials indicated above in connection with Example 1 but using the foam formulation of Control Number 3, except that a compound found to have the ability to enhance certain foam physical properties when used in accordance with the present invention, including but not limited to compression set, namely, a polyether triol is added in an amount of about 15 equivalent weight. The polyether triol has a molecular weight (avg.) of about 265, a hydroxyl number (avg.) of about 648, and a maximum acid number of about 0.05 (mg KOH/g), a maximum water content of about 0.03, a pH-1 (avg.) of about 6.3, a color (max—APHA) of about 50, a viscosity (cps at 25 C) of about 930, and a specific gravity (at 25 C) of about 1.091, and is sold under the trade designation Poly-G 76-635 by Arch Chemicals. Inc.

The foams so produced are tested and found to have the following average physical

| | CONTROL | EXAMPLE 11 | % CHANGE |
|---|---|---|---|
| DENSITY, PCF | 2.48 | 2.21 | −11 |
| IFD 25% | 129 | 138 | 7 |
| IFD 65% | 314 | 329 | 5 |
| Comfort | 2.43 | 2.38 | −2 |
| Tensile Strength, psi | 15.5 | 16.6 | 7 |
| Elongation | 84.5 | 81 | −4 |
| Compression (at | 13.5 | 21.2 | 57 |
| 70° C.) | | | |

Although the invention has been described in detail in the foregoing for the purposes including explanation and illustration, it is to be understood that all of the recited detail is not necessarily limiting of the invention and that variations can be made therein by those skilled in the art without departing from the spirit and scope of the invention except as it may be limited by the claims presented herein below and as amended hereinafter.

1. A method of forming a flexible, open cell foam comprising:
(a) providing a foamable, thermosetting composition capable of forming an open-cell, flexible foam, said composition comprising (i) one or more components capable of forming a thermoset matrix; and (ii) a blowing agent for forming open cells in said matrix, said blowing agent comprising at least one chemical blowing agent and at least one physical blowing agent comprising HFO-1336mzz; and
(b) forming from said foamable composition a flexible foam comprising a matrix comprising said thermoset polymer and a plurality of open cells in said matrix, said foam having a density of not greater than about 4 pounds per cubic foot.

2. A method of forming flexible, open cell foam into the shape of an automobile seat cushion comprising:
(a) providing a foamable composition capable of forming an open-cell, flexible polyurethane foam, said composition comprising (i) at least one MDI; (ii) at least one polyol; (iii) catalyst; and (iv) a blowing agent for forming open cells in said foam, said blowing agent comprising from about 70 to about 99 mole percent water and from about 1 to about 30 mole percent of a co-blowing agent comprising HFO-1336mzz; and
(b) forming said foamable composition into a flexible, open-cell polyurethane foam having: (i) a density of not greater than about 4 pounds per cubic foot, said density of said foam being at least about 8 relative percent less than the density of said foam produced using the same method but without said co-blowing agent; (ii) a compression set of not greater than about 15; (iii) and a comfort value of from about 2 to about 3.

3. A foamable composition comprising (a) one or more components capable of forming a thermoset matrix having open cells; and (b) a blowing agent for forming open cells in said matrix, said blowing agent comprising from about 80 mol % to about 97 mol % water and from about 3 mol % to about 20 mol % of a co-blowing agent, said co-blowing agent comprising HFO-1336mzz.

4. A blowing agent composition consisting essentially of from about 80 mol % to about 97 mol % water and from about 3 mol % to about 20 mol % of a co-blowing agent, said co-blowing comprising in a major proportion by mole HFO-1336mzz.

5. A method of forming a flexible, open cell foam comprising:
(a) providing a foamable, thermosetting composition capable of forming an open-cell, flexible foam, said composition comprising (i) one or more components capable of forming a thermoset matrix; and (ii) a blowing agent for forming open cells in said matrix, said blowing agent comprising water and comprising HFO-1.336mzz; and
(b) forming from said foamable composition a flexible foam comprising a matrix comprising thermoset polymer and a plurality of open cells in said matrix, said foam having a density of not greater than about 2.6 pounds per cubic foot.
